(19) United States
(12) Patent Application Publication
(10) Pub. No.: US 2024/0378359 A1
(43) Pub. Date: Nov. 14, 2024

(54) SYSTEM SIMULATION USING SIMULATION MODELS EXECUTING ON VIRTUAL PROCESSORS

(71) Applicant: Synopsys, Inc., Sunnyvale, CA (US)

(72) Inventors: Simon John Davidmann, Oxford (GB); Matthew Hall, Oxford (GB); Giacomo Correnti, Oxford (GB)

(21) Appl. No.: 18/660,014

(22) Filed: May 9, 2024

(30) Foreign Application Priority Data
May 10, 2023 (GB) 2306912.3

(51) Int. Cl. G06F 30/3312; G06F 119/12

(52) U.S. Cl. CPC G06F 30/3312; G06F 2119/12

(57) ABSTRACT

Simulating a system involves running a simulation model on a virtual processor that interfaces to a simulator, the virtual processor being associated with a unique memory space in the memory space used by the simulator. The virtual processor technique gives the developer a simple technique for ensuring the model and simulator interactions are managed effectively, i.e. that no unintentional corruptions of each other's memory space are possible. It also facilitates making multiple instantiations of a C, C++ or other general purpose programming language model. The resulting environment also resolves one of the limitations on the use of third party models within the SystemC environment.

### RELATED APPLICATION

This application claims priority to GB Patent Application Serial No. 2306912.3, “A Method of Simulating a Microprocessor System,” filed May 10, 2023. The subject matter of all of the foregoing is incorporated herein by reference in its entirety.

### TECHNICAL FIELD

The present disclosure relates to simulating systems using simulation models and virtual processors.

### BACKGROUND

One area which is important to the design and development of integrated circuits (ICs) is the availability of high quality simulation models. These may be used to represent various components of the simulation. For example simulation models may be used to represent components within the IC device being developed or to represent components of the environment in which the device will operate. These models make it possible for the system with the IC (and possibly other devices) to be simulated using available software simulation programs, thus testing the design fully before it is committed to silicon. In the ESL (Electronic System Level) arena, the development process has an even greater dependency on these models than RTL (Register Transfer Level) based design.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 is a block diagram of multiple simulation models each executing on its own virtual processor, in accordance with some embodiments of the present disclosure.

FIG. 2 is a block diagram of a simulation model executing on multiple virtual processors, in accordance with some embodiments of the present disclosure.

FIG. 3 is a block diagram of multiple instances of a simulation model, each instance executing on its own virtual processor, in accordance with some embodiments of the present disclosure.

FIG. 4 is a block diagram of simulation models using different version libraries, in accordance with some embodiments of the present disclosure.

FIG. 5 depicts a flowchart of various processes used during the design and manufacture of an integrated circuit in accordance with some embodiments of the present disclosure.

FIG. 6 depicts a diagram of an example computer system, wherein embodiments of the present disclosure may operate.

### DETAILED DESCRIPTION

Aspects of the present disclosure relate to system simulation using simulation models executing on virtual processors. Simulations are important in the design and development of systems that include integrated circuits. Simulation ensures that the integrated circuit is operating properly before it is committed to manufacturing. Many simulations may make use of simulation models or other components. A simulator runs the simulation of the overall system, which simulation incorporates the simulation models.

For example, the system may include a system-on-chip (SoC) integrated circuit, which includes IP blocks provided by third parties. Common IP blocks include processors, I/O functions and memory. The designer of the SoC may not have full visibility into the IP blocks. Rather than providing the source code for an IP block, the third party may provide a simulation model. The simulation of the SoC then uses the simulation model for the IP block.

These simulations usually rely on models written in C or other general purpose programming languages to represent portions of the design (i.e. a simulation model written in the C or other general purpose programming language). One approach to simulation is to incorporate the models into the simulator by rebuilding the simulator executable with the model code included. The combined executable then allows the designer to simulate the full system, which includes both the models and the device under test.

For example, if the system is a microprocessor system, the simulation models may represent different components of the microprocessor design. The executable of the simulator may be rebuilt to expressly include these models to generate a combined simulator executable.

However, this approach has a number of drawbacks. The resulting combined simulator executable is a combination of the models and the original simulator. There may be conflicts between the different pieces of code which have been combined. It is therefore quite possible that one part of the code writes to a memory space which is being used by another part of the code, thus altering the data which the second part expected to find and so corrupting the simulation run. In addition, it is difficult to establish which part of the code is causing the corruptions. Once the parts are combined, it is not a simple matter to determine whether any errors which occur in the simulation originate with the models or the original simulator code.

Another drawback to this technique is that it also requires a means by which the models can be instantiated, with the simulator controlling the interactions between them. However, the process of making multiple instantiations of models written in C or other programming languages, may not be a trivial task. For example, in the case of C language models, the method of making multiple instantiations is defined by the IEEE standard 1499 and is a complex process. SystemC provides an alternative method using the C++ language, but this needs complex library support.

The ideal solution requires the use of a model, written in C or any other general purpose programming language, with a mechanism for combining the model with the simulator without needing the two to be compiled and linked together as described above. It also requires a mechanism fit for creating multiple instances easily.

This disclosure describes a technique which avoids these difficulties. The simulation models are not combined with the simulator. Rather, the models are executed by virtual processors, which are associated with unique memory spaces in the memory space used by the simulator. The virtual processors interface to the simulator.

Technical advantages of this approach include the following. It allows, in one implementation, the simulation of models in a way which does not require the rebuilding of the simulator code with “foreign” model code inside it. It also avoids data conflicts caused by different pieces of code accessing the same memory space. The technique can also allow the multi-instantiation of C, C++ and other general purpose programming language based models in a simple way.

The technique described in this disclosure is that of virtualizing the models. The simulation model, traditionally linked into the simulator, is kept separate from the simulator. This is done by providing a virtual processor on which the code for the model is run. A virtual processor is a representation of a particular processor, such as an x86, such that it appears that there is an x86 present and on which x86 code will run, but which has resources mapped by software to the real system on which it runs. In an implementation, this virtual processor uses a specially defined interface to the simulator and specifies the unique memory space for the virtual processor as well as the appropriate port definitions, which have the effect of connecting it to the rest of the simulation. The result is that now the simulation processes can manage all access to memory by any part of the code and any circumstances which would have resulted in overwritten or corrupted data using the combined executable technique can be trapped and resolved. The model code, written in C, C++ or any other general purpose programming language, is loaded either onto one virtual processor per model or across multiple virtual processors.

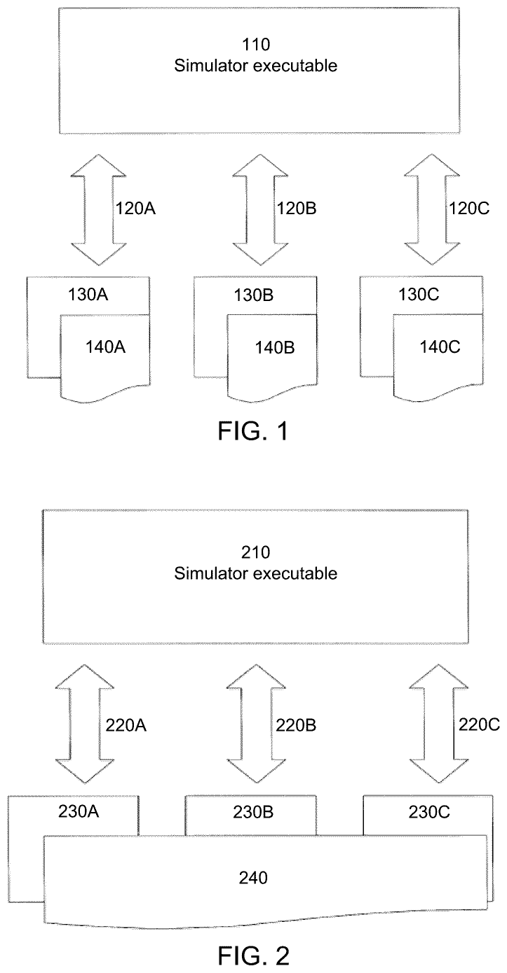

FIG. 1 is a block diagram of multiple simulation models each executing on its own virtual processor, in accordance with some embodiments of the present disclosure. FIG. 1 shows multiple simulation models 140A-C, each of which is executed on its own virtual processor 130A-C. Each virtual processor 130A-C has an interface 120A-C to the simulator 110. The simulator runs the overall simulation and uses a memory space for the simulation. Each virtual processor 130A-C is associated with a unique memory space in the memory space used by the simulator, thus avoiding any memory conflicts.

FIG. 2 is a block diagram of a simulation model executing on multiple virtual processors, in accordance with some embodiments of the present disclosure. FIG. 2 shows a simulation models 240, which is executed across several virtual processors 230A-C. Each virtual processor 230A-C has an interface 220A-C to the simulator 210 and is associated with a unique memory space.

Combinations of FIGS. 1 and 2 are also possible. Any number of simulation models may be executed on any number of virtual processors.

This technique also supports multiple instantiations of the models, as shown in FIG. 3. Instances 340A-C of the same model are executed by different virtual processors 330A-C, with a different memory address associated with each one, thus making the many instances 340 independent. The virtual processors 330A-C have interfaces 320A-C to the simulator 310. As in the previous figures, the simulation process 310 handles the correct access to the allocated memory space for each instance 330A-C of the model's use.

The technique may be applied to any code written in C, C++ or any other general purpose programming language, and so includes not only simulation models, but also test-bench code, as well as those models written during the development of the device under test. Test-bench code is that code which is written solely for the purpose of testing the device which is being simulated and does not describe any part of the device or devices under test, but may describe the environment outside them.

The use of the virtual processor technique means that a design can easily be scaled from, for example, a single processor to a bank of processors or from a single computer to a bank of computers. This is because multiple instantiations of any model no longer require complex rewriting. Previously, using any C or C++ based model more than once within a system would have required a complicated rewrite of that model to make that possible. The use of virtual processors, however, makes each of the uses of any model independent of each other because each is running on a separate virtual processor(s) so it is not necessary to rewrite the model if the virtual processor technique is used. This means that scaling from one instance to many instances of any model within a simulated system, whether that is a simple block or an entire system model, is now possible without rewriting the code through the use of this technique.

In some cases, certain operations may not be supported in the virtual space. These include operations such as file access where the actual file needs to be available. This can be resolved using one of two techniques. The first is to define a pseudo file area, within the simulation, which is defined uniquely for each instance of the model; the second is to allow the definition of a file storage area for each instance of the model which relates to a real area within the file system of the machine or machines on which the simulation is running.

A further application of this technique is within SystemC or similar development environments. If all of the models are linked and compiled together into a single SystemC environment, then they must be compiled using the same version of the SystemC environment. If they are compiled using different versions, as these point to different versions of the SystemC libraries, incompatibilities occur which result in fatal errors.

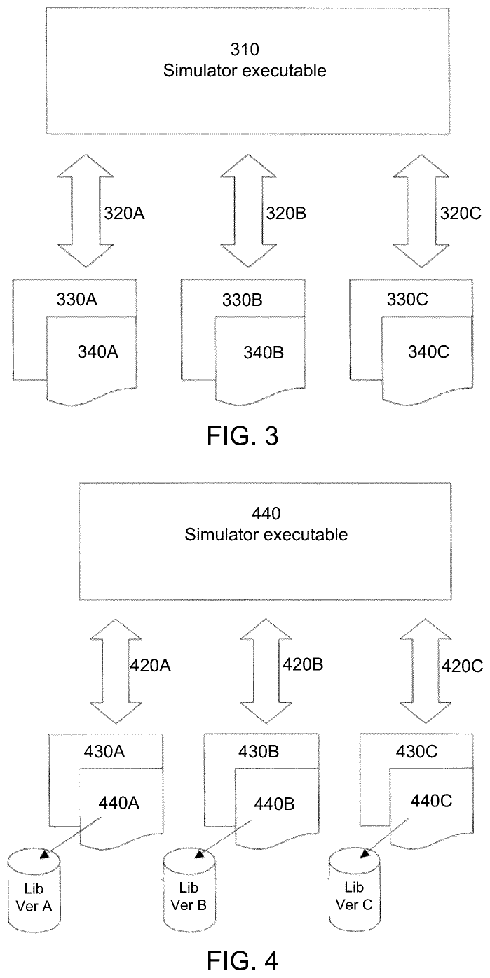

The use of the virtual model technique that has been described above can be extended to allow the various System C models to be kept separate and each one run on an independent virtual processor, as shown in FIG. 4. The same results of simulator controlled interactions, managed through the simulator interface, overcomes the issue of models compiled on different versions of SystemC. This is because each SystemC model is run a separate virtual processor and the issues of different versions no longer exist as only one version is required per virtual processor.

FIG. 4 is a block diagram of simulation models using different version libraries, in accordance with some embodiments of the present disclosure. FIG. 4 shows simulation models 440A-C using different library versions A-C. These models 440A-C are executed by different virtual processors 430A-C. Each virtual processor 430A-C has an interface 420A-C to the simulator 410 and is associated with a unique memory space.

The use of the virtual model techniques allows the developer access to a simple technique for making multiple instantiations of a C, C++ or general purpose programming language model and ensuring the model and simulator interactions are managed effectively, thus ensuring that no unintentional corruptions of each other's memory space are possible. The resulting environment also resolves one of the limitations on the use of third party models within the SystemC environment, for which source code may not be available.

One area for careful management in a virtual processor based simulation is that of ensuring that all parts of the simulation are synchronized with respect to time. Any part of the simulation, models, peripherals and test-bench code may contain delays or timing information. The simulator maintains control of this. This is done by ensuring that the scheduling of all delay events takes place in an event queue outside of the virtual processors. When control is passed temporarily to any virtual processor in the simulation, the passage of simulation time is suspended in the simulation itself. When the virtual processor yields control back to the simulator, simulation time can be advanced. Any delays which then need to be passed back to the entire simulation, such as a WAIT instruction would be passed through calls which infer the passage of time. These calls are handled by the simulator itself rather than by the virtual processor.

A first aspect of the invention is a method of simulating a microprocessor system, wherein the method comprises the step of running a simulation model on a virtual processor that interfaces to a simulator, the virtual processor being associated with a unique memory space in the memory space used by the simulator.

In one implementation, multiple models each run on their own virtual processor, each virtual processor being associated with its own unique memory space in the memory space used by the simulator. In another implementation, a single model runs across multiple virtual processors, each virtual processor being associated with its own unique memory space in the memory space used by the simulator.

In another implementation, multiple instantiations of the model can each run on their own virtual processor, each virtual processor being associated with its own unique memory space in the memory space used by the simulator.

The model may be written in any general purpose programming language, such as C or C++. It may also be written in a discrete event simulation language, such as SystemC. There can be multiple models using different versions of SystemC, each running on a separate virtual processor.

Another aspect is a microprocessor designed using the method of simulating a microprocessor defined above.

A final aspect is a microprocessor comprising a hardware computational unit that implements a model of hardware behavior, the model running on a virtual processor associated with a unique memory space in the memory space used by the microprocessor.

Other aspects include components, devices, systems, improvements, methods, processes, applications, computer readable mediums, and other technologies related to any of the above.

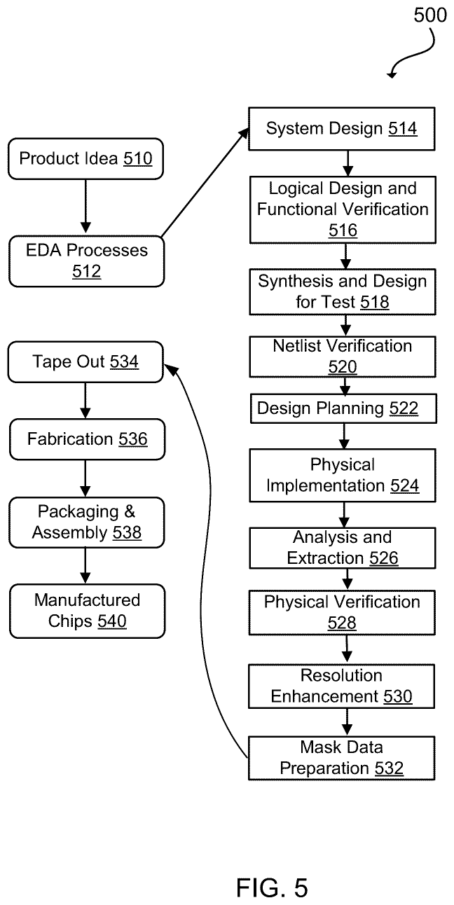

FIG. 5 illustrates an example set of processes 500 used during the design, verification, and fabrication of an article of manufacture such as an integrated circuit to transform and verify design data and instructions that represent the integrated circuit. Each of these processes can be structured and enabled as multiple modules or operations. The term ‘EDA’ signifies the term ‘Electronic Design Automation.’ These processes start with the creation of a product idea 510 with information supplied by a designer, information which is transformed to create an article of manufacture that uses a set of EDA processes 512. When the design is finalized, the design is taped-out 534, which is when artwork (e.g., geometric patterns) for the integrated circuit is sent to a fabrication facility to manufacture the mask set, which is then used to manufacture the integrated circuit. After tape-out, a semiconductor die is fabricated 536 and packaging and assembly processes 538 are performed to produce the finished integrated circuit 540.

Specifications for a circuit or electronic structure may range from low-level transistor material layouts to high-level description languages. A high-level of representation may be used to design circuits and systems, using a hardware description language (‘HDL’) such as VHDL, Verilog, System Verilog, SystemC, MyHDL or Open Vera. The HDL description can be transformed to a logic-level register transfer level (‘RTL’) description, a gate-level description, a layout-level description, or a mask-level description. Each lower representation level that is a more detailed description adds more useful detail into the design description, for example, more details for the modules that include the description. The lower levels of representation that are more detailed descriptions can be generated by a computer, derived from a design library, or created by another design automation process. An example of a specification language at a lower level of representation language for specifying more detailed descriptions is SPICE, which is used for detailed descriptions of circuits with many analog components. Descriptions at each level of representation are enabled for use by the corresponding systems of that layer (e.g., a formal verification system). A design process may use a sequence depicted in FIG. 5. The processes described by be enabled by EDA products (or EDA systems).

During system design 514, functionality of an integrated circuit to be manufactured is specified. The design may be optimized for desired characteristics such as power consumption, performance, area (physical and/or lines of code), and reduction of costs, etc. Partitioning of the design into different types of modules or components can occur at this stage.

During logic design and functional verification 516, modules or components in the circuit are specified in one or more description languages and the specification is checked for functional accuracy. For example, the components of the circuit may be verified to generate outputs that match the requirements of the specification of the circuit or system being designed. Functional verification may use simulators and other programs such as testbench generators, static HDL checkers, and formal verifiers. In some embodiments, special systems of components referred to as ‘emulators’ or ‘prototyping systems’ are used to speed up the functional verification.

During synthesis and design for test 518, HDL code is transformed to a netlist. In some embodiments, a netlist may be a graph structure where edges of the graph structure represent components of a circuit and where the nodes of the graph structure represent how the components are interconnected. Both the HDL code and the netlist are hierarchical articles of manufacture that can be used by an EDA product to verify that the integrated circuit, when manufactured, performs according to the specified design. The netlist can be optimized for a target semiconductor manufacturing technology. Additionally, the finished integrated circuit may be tested to verify that the integrated circuit satisfies the requirements of the specification.

During netlist verification 520, the netlist is checked for compliance with timing constraints and for correspondence with the HDL code. During design planning 522, an overall floor plan for the integrated circuit is constructed and analyzed for timing and top-level routing.

During layout or physical implementation 524, physical placement (positioning of circuit components such as transistors or capacitors) and routing (connection of the circuit components by multiple conductors) occurs, and the selection of cells from a library to enable specific logic functions can be performed. As used herein, the term ‘cell’ may specify a set of transistors, other components, and interconnections that provides a Boolean logic function (e.g., AND, OR, NOT, XOR) or a storage function (such as a flipflop or latch). As used herein, a circuit ‘block’ may refer to two or more cells. Both a cell and a circuit block can be referred to as a module or component and are enabled as both physical structures and in simulations. Parameters are specified for selected cells (based on ‘standard cells’) such as size and made accessible in a database for use by EDA products.

During analysis and extraction 526, the circuit function is verified at the layout level, which permits refinement of the layout design. During physical verification 528, the layout design is checked to ensure that manufacturing constraints are correct, such as DRC constraints, electrical constraints, lithographic constraints, and that circuitry function matches the HDL design specification. During resolution enhancement 530, the geometry of the layout is transformed to improve how the circuit design is manufactured.

During tape-out, data is created to be used (after lithographic enhancements are applied if appropriate) for production of lithography masks. During mask data preparation 532, the ‘tape-out’ data is used to produce lithography masks that are used to produce finished integrated circuits.

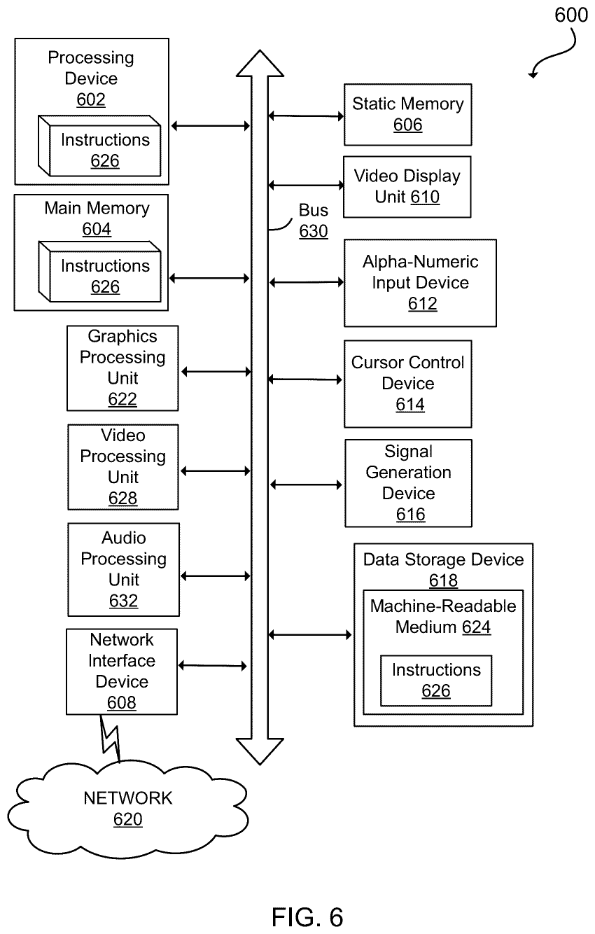

A storage subsystem of a computer system (such as computer system 600 of FIG. 6) may be used to store the programs and data structures that are used by some or all of the EDA products described herein, and products used for development of cells for the library and for physical and logical design that use the library.

FIG. 6 illustrates an example machine of a computer system 600 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM), a static memory 606 (e.g., flash memory, static random access memory (SRAM), etc.), and a data storage device 618, which communicate with each other via a bus 630.

Processing device 602 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. The processing device 602 may be configured to execute instructions 626 for performing the operations and steps described herein.

The computer system 600 may further include a network interface device 608 to communicate over the network 620. The computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse), a graphics processing unit 622, a signal generation device 616 (e.g., a speaker), graphics processing unit 622, video processing unit 628, and audio processing unit 632.

The data storage device 618 may include a machine-readable storage medium 624 (also known as a non-transitory computer-readable medium) on which is stored one or more sets of instructions 626 or software embodying any one or more of the methodologies or functions described herein. The instructions 626 may also reside, completely or at least partially, within the main memory 604 and/or within the processing device 602 during execution thereof by the computer system 600, the main memory 604 and the processing device 602 also constituting machine-readable storage media.

In some implementations, the instructions 626 include instructions to implement functionality corresponding to the present disclosure. While the machine-readable storage medium 624 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 602 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

What is claimed is:

1. A method comprising:
running a simulator that runs a simulation of a system; wherein the system comprises an integrated circuit device under test (DUT), and the simulator uses a memory space for the simulation; and
executing, by a virtual processor, a simulation model of a component of the simulation; wherein the virtual processor interfaces to the simulator, and the virtual processor is associated with a unique memory space in the memory space used by the simulator.

2. The method of claim 1, wherein the simulation model is a simulation model of a component within the DUT.

3. The method of claim 1, wherein the simulation model is a simulation model of an environment within which the DUT operates.

4. The method of claim 1, wherein the simulation is an ESL (Electronic System Level) simulation.

5. The method of claim 1, wherein the DUT is a system-on-chip integrated circuit (SoC), the component is a third party IP block within the SoC, and the simulation model of the third party IP block is provided by the third party.

6. The method of claim 1, wherein running the simulator comprises: scheduling delay events in an event queue outside of the virtual processor.

7. The method of claim 1, further comprising:
passing control of the simulation to the virtual processor and, when control is passed to the virtual processor, suspending a passage of simulation time in the simulation; and
passing control of the simulation back to the simulator and, when control is passed back to the simulator, advancing the passage of simulation time.

8. A system comprising:
a processing device running a simulator that runs a simulation of a system, wherein the system comprises an integrated circuit device under test (DUT), and the simulator uses a memory space for the simulation;
virtual processors executing simulation models of components of the simulation; wherein the virtual processors are associated with unique memory spaces in the memory space used by the simulator; and
interfaces between the virtual processors and the simulator.

9. The system of claim 8, wherein the virtual processors further execute a test-bench code for the simulation.

10. The system of claim 8, wherein at least one of the simulation models is a simulation model written during a development of the DUT.

11. The system of claim 8, wherein multiple of the simulation models execute on their own virtual processors.

12. The system of claim 8, wherein at least one of the simulation models executes across multiple virtual processors.

13. The system of claim 8, wherein multiple instantiations of a single simulation model execute on their own virtual processors.

14. The system of claim 8, wherein the simulation is scalable to multiple instances of the components, without rewriting the simulation models.

15. The system of claim 8, wherein the simulation models are written in different programming languages and/or different versions of programming languages.

16. A non-transitory computer readable medium comprising stored instructions, which when executed by a processing device, cause the processing device to execute a simulation model on a virtual processor that interfaces to a simulator, the virtual processor being associated with a unique memory space in a memory space used by the simulator.

17. The non-transitory computer readable medium of claim 16, wherein the simulation model is written in a general purpose programming language.

18. The non-transitory computer readable medium of claim 16, wherein the simulation model is written in a discrete event simulation language.

19. The non-transitory computer readable medium of claim 16, wherein the instructions cause the processing device to execute a plurality of simulation models, at least one of the simulation models is written in a general purpose programming language and at least another of the simulation models is written in a discrete event simulation language.

20. The non-transitory computer readable medium of claim 19, wherein the one simulation model is written in C and the other simulation model is written in SystemC.
